(19) United States
(12) Patent Application Publication
(10) Pub. No.: US 2018/0045218 A1
(43) Pub. Date: Feb. 15, 2018

(54) SHIM FOR GAS TURBINE ENGINE

(71) Applicant: United Technologies Corporation, Farmington, CT (US)

(72) Inventor: Louis R. Mouza, Haverhill, MA (US)

(21) Appl. No.: 15/234,007

(22) Filed: Aug. 11, 2016

(51) Int. Cl. F04D 29/40; F04D 29/08

(52) U.S. Cl. CPC F04D 29/403; F04D 29/083; F05D 2220/32; F05D 2240/14; F05D 2240/55; F05D 2260/941

(57) ABSTRACT

A joint for a gas turbine engine includes a first component, a second component, an annular shim disk, and fasteners. The first component has a first ring portion and a first annular radial flange that extends from the first ring portion. The second component has a second ring portion and a second annular radial flange that extends from the second ring portion. The first annular radial flange and the second annular radial flange are spaced apart by a gap that has a variable gap size that is subject to a stacking tolerance. The annular shim disk is disposed in the gap. The fasteners are secured through the first annular radial flange, the annular shim disk, and the second annular radial flange.

### BACKGROUND

A gas turbine engine typically includes a fan section, a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

The high pressure turbine drives the high pressure compressor through an outer shaft to form a high spool, and the low pressure turbine drives the low pressure compressor through an inner shaft to form a low spool. The fan section may also be driven by the low inner shaft. A direct drive gas turbine engine includes a fan section driven by the low spool such that the low pressure compressor, low pressure turbine and fan section rotate at a common speed in a common direction.

A speed reduction device, such as an epicyclical gear assembly, may be utilized to drive the fan section such that the fan section may rotate at a speed different than the turbine section. In such engine architectures, a shaft driven by one of the turbine sections provides an input to the epicyclical gear assembly that drives the fan section at a reduced speed.

### SUMMARY

A joint for a gas turbine engine according to an example of the present disclosure includes a first component that has a first ring portion and a first annular radial flange extending from the first ring portion, and a second component that has a second ring portion and a second annular radial flange extending from the second ring portion. The first annular radial flange and the second annular radial flange are spaced apart by a gap that has a variable gap size that is subject to a stacking tolerance. An annular shim disk is disposed in the gap, and a plurality of fasteners are secured through the first annular radial flange, the annular shim disk, and the second annular radial flange.

In a further embodiment of any of the foregoing embodiments, the annular shim disk is monolithic.

In a further embodiment of any of the foregoing embodiments, the annular shim disk includes a plurality of circular orifices through which the plurality of fasteners are secured.

In a further embodiment of any of the foregoing embodiments, the circular orifices are circumferentially-arranged in a series that is uninterrupted by any non-circular orifices.

In a further embodiment of any of the foregoing embodiments, the circular orifices are non-uniformly circumferentially-arranged.

In a further embodiment of any of the foregoing embodiments, the second annular radial flange is scalloped.

In a further embodiment of any of the foregoing embodiments, the first component includes an air seal extending from the first ring portion. The first annular radial flange extends radially outwards from the first ring portion and the air seal extends radially inwards from the first ring portion.

In a further embodiment of any of the foregoing embodiments, the annular shim disk has radially inner and outer edges, and uniform axial thickness from the radially outer edge to the radially inner edge.

A gas turbine engine according to an example of the present disclosure includes a compressor section that has a plurality of compressor case segments that are in a stacked arrangement along an axis. The compressor case segments have respective axial dimensions which are variable within respective dimensional tolerances. The stacked arrangement has a stacked dimension which is variable within a stacking tolerance corresponding to the dimensional tolerances. A joint has a first component that has a first ring portion and a first annular radial flange extending from the first ring portion. The first component is stacked adjacent the second compressor case. A second component has a second ring portion and a second annular radial flange extending from the second ring portion. The second component is affixed such that the first annular radial flange and the second annular radial flange are spaced apart by a gap that has a variable gap size that is subject to the stacking tolerance. An annular shim disk is disposed in the gap, and a plurality of fasteners are secured through the first annular radial flange, the annular shim disk, and the second annular radial flange.

In a further embodiment of any of the foregoing embodiments, the compressor section includes a low pressure compressor and a high pressure compressor, and the joint is located in the high pressure compressor.

In a further embodiment of any of the foregoing embodiments, the joint is at an aft end of the high pressure compressor.

In a further embodiment of any of the foregoing embodiments, the annular shim disk is monolithic.

In a further embodiment of any of the foregoing embodiments, the annular shim disk includes a plurality of circular orifices through which the plurality of fasteners are secured.

In a further embodiment of any of the foregoing embodiments, the circular orifices are circumferentially-arranged in a series that is uninterrupted by any non-circular orifices.

In a further embodiment of any of the foregoing embodiments, the circular orifices are non-uniformly circumferentially-arranged.

In a further embodiment of any of the foregoing embodiments, the second annular radial flange is scalloped.

In a further embodiment of any of the foregoing embodiments, the first component includes an air seal extending from the first ring portion, the first annular radial flange extending radially outwards from the first ring portion and the air seal extending radially inwards from the first ring portion.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example gas turbine engine.

FIG. 2 illustrates an example of a stacked arrangement of a compressor case.

FIG. 3 illustrates an example joint in the engine of FIG. 1.

FIG. 4A illustrates an axial view of an annular shim disk.

FIG. 4B illustrates a partial view of the annular shim disk of FIG. 4A.

FIG. 5 illustrates a sectioned view of the annular shim disk of FIG. 4B.

FIG. 6 illustrates a partial view of a component of a joint.

### DETAILED DESCRIPTION

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engine designs can include an augmentor section (not shown) among other systems or features.

The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, the examples herein are not limited to use with two-spool turbofans and may be applied to other types of turbomachinery, including direct drive engine architectures, three-spool engine architectures, and ground-based turbines.

The engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48, to drive the fan 42 at a lower speed than the low speed spool 30.

The high speed spool 32 includes an outer shaft 50 that interconnects a second (or high) pressure compressor 52 and a second (or high) pressure turbine 54. A combustor 56 is arranged between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports the bearing systems 38 in the turbine section 28. The inner shaft 40 and the outer shaft 50 are concentric and rotate via bearing systems 38 about the engine central longitudinal axis A, which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines, including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second.

The compressor section 24 of the engine 20 includes a compressor case 62. The compressor case 62 may be a sectioned case that has a plurality of annular compressor case segments 64, which are shown in FIG. 2. Although shown schematically, each case segment 64 may have a different geometry in accordance with the axial position of the given case segment 64 in the compressor section 24. The case segments 64 are stacked together during assembly of the compressor section 24, as represented at 66, to form a stacked arrangement 68. The case segments 64 may be stacked directly in contact with each other or there may be seals or other intermediary components between the case segments 64. Although three case segments 64 are shown, it is to be understood that the stacked arrangement 68 may have two case segments 64 or additional case segments. For instance, the stacked arrangement 68 has seven or eight case segments 64.

The case segments 64 have respective axial dimensions, represented at D1, D2, and D3, which are variable within respective dimensional tolerances, represented at T1, T2, and T3. The stacked arrangement 68 has a stacked dimension, represented at D4, which is variable within a stacking tolerance, represented at T4. The stacking tolerance T4 corresponds to the dimensional tolerances D1, D2, and D3. For example, if the dimensional tolerances D1, D2, and D3 were each+/−2 units, the stacking tolerance T4 may be+/−6 units. If the dimensional tolerances D1, D2, and D3 were, respectively, +/−1 unit, +/−2 units, and +/−2 units, the stacking tolerance T4 may be+/−5 units. In practice, actual stacking tolerance may be reduced through selection of the case segments 64.

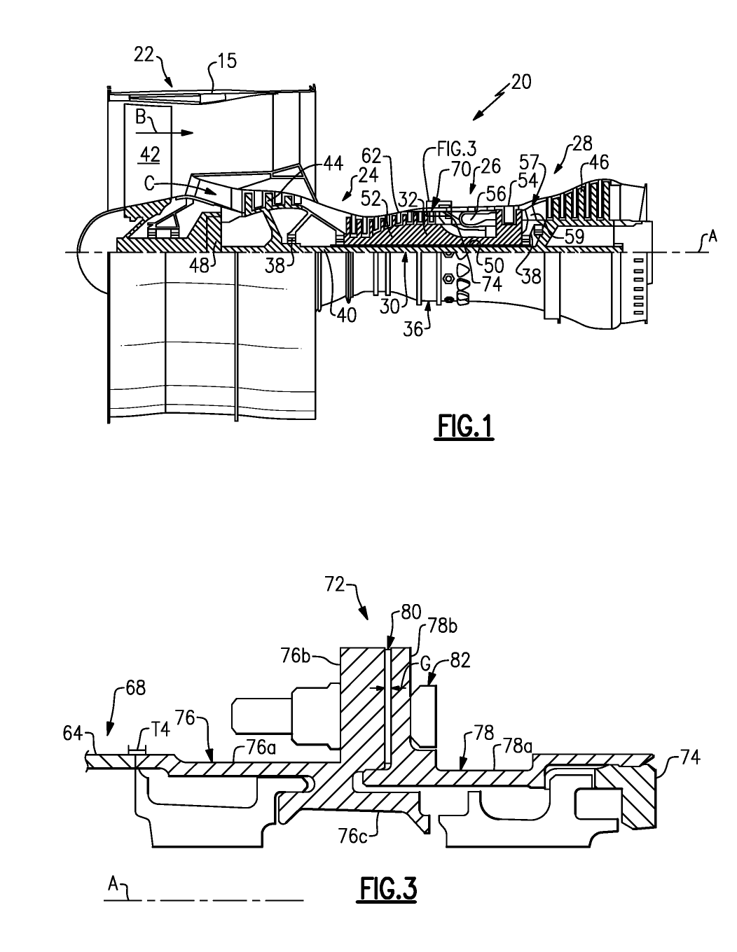

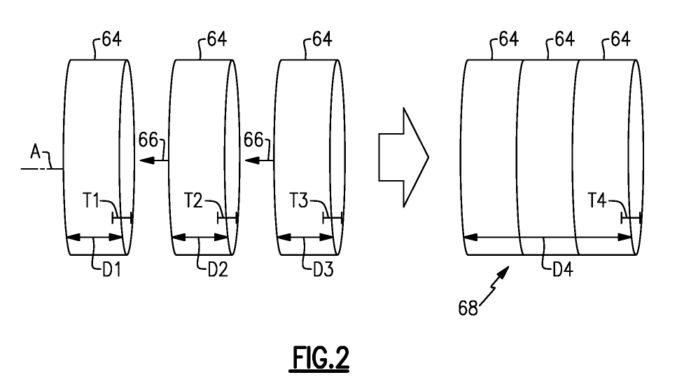

FIG. 3 depicts a location at an aft end 70 of the high pressure compressor 52. The aft end 70 includes a joint 72 between the rear of the stacked arrangement 68 and an inner diffuser 74, which is just prior to the combustor 56. The joint 72 includes a first component 76, a second component 78, an annular shim disk 80, and a plurality of fasteners 82 (one shown), such as bolts, that secure the annular shim disk 80 between the first component 76 and the second component 78.

The first component 76 in this example includes a first ring portion 76a and a first annular radial flange 76b that extends radially outwards from the first ring portion 76a. In this example, the first component 76 also includes an air seal 76c that extends radially inwards from the first ring portion 76a. In other types of joints the first component may not have an air seal. The second component 78 in this example includes a second ring portion 78a and a second annular radial flange 78b that extends radially outwards from the second ring portion 78a. The first annular radial flange 76b and the second annular radial flange 78b are spaced apart by a gap, represented at G.

The second component 78, which in this example is a seal ring, is affixed with respect to the diffuser 74 or other component in the engine 20. The first component 76 is adjacent the stacked arrangement 68. The axial position of the first component 76 is thus dependent on the position of the stacked arrangement 68, which can vary in accordance with the stacking tolerance T4. Therefore, the gap G has a variable gap size that is subject to the stacking tolerance T4. The annular shim disk 80 may be selected from among a group of similar annular shim disks that have different sizes to fill gaps G of different gap sizes. The flanges 76b/78b have orifices for receiving the fasteners 82.

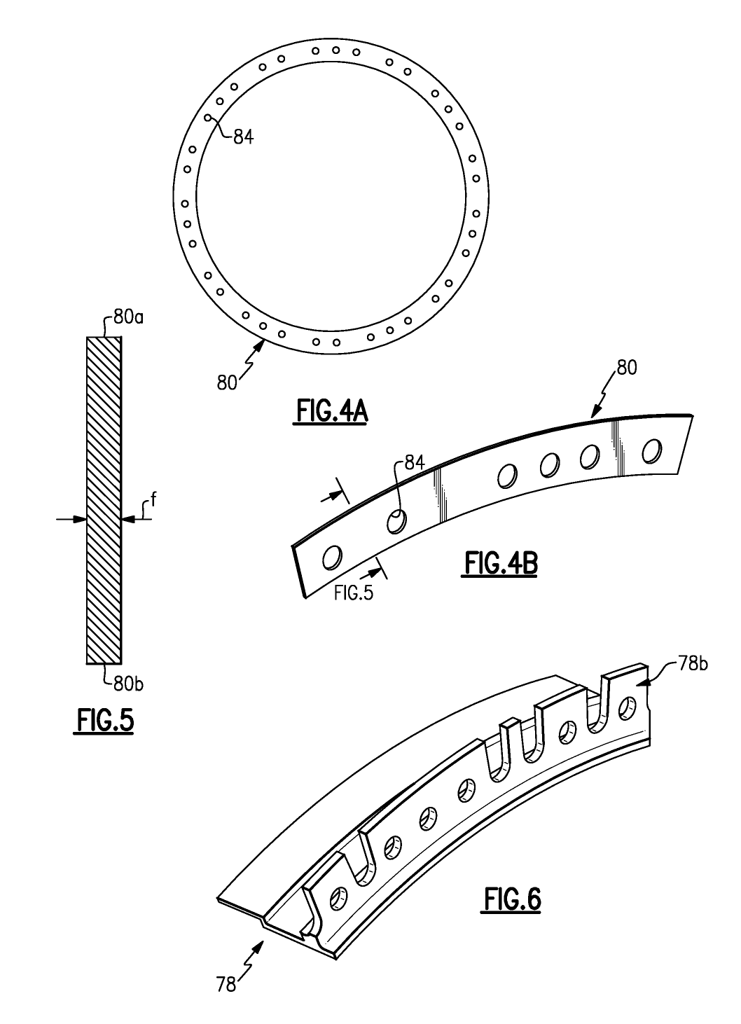

As shown in FIGS. 4A and 4B, the annular shim disk 80 has circular orifices 84, which axially align with the orifices in the flanges 76b/78b to receive the fasteners 82 there through. The circular orifices 84 are circumferentially-arranged. For instance, the circular orifices 84 may be non-uniformly arranged to provide mistake-proof assembly of the annular shim disk 80 in only one orientation. Additionally, the circular orifices 84 may be circumferentially-arranged in a series that is uninterrupted by any non-circular orifices. As an example, the annular shim disk 80 does not have any elongated slots or other openings in between the circular orifices.

The annular shim disk 80 is a single-piece ring. For example, the single-piece ring can be a monolithic body that does not have seams or the ring can be formed from arc segments that are metallurgically affixed together to form a single piece. In one example, the ring is machined as a single-piece from a starting workpiece.

As shown in FIG. 5, the annular shim disk 80 has an outer edge 80a, an inner edge 80b, and a uniform axial thickness, represented at t, from the outer edge 80a to the inner edge 80b. For instance, the annular shim disk 80 has the same or substantially same axial thickness at all circumferential locations.

The annular shim disk 80 serves to fill the gap G and reduce stresses on the first component 76 and the second component 78 in comparison to a segmented shim (described further below). The fasteners 82 clamp the annular shim disk 80 between the flanges 76b/78b. The uniform thickness of the annular shim disk 80 facilitates the reduction of stress concentrations on the flanges 76b/78b under the clamping force. Additionally, one or both of the flanges 76b/78b may mechanically and/or thermally deflect during operation of the engine 20. In particular, as shown in FIG. 6, the second annular radial flange 78b of the second component 78 (e.g., a seal ring) may be scalloped, which may permit a greater degree of deflection and thus a greater potential to produce elevated local stresses. Such scalloping may be used to permit rapid thermal change during engine acceleration to accommodate dimensional changes in other components, such as an integrally bladed rotor in the compressor section 24.

Such deflection potentially applies a local load on the annular shim disk 80. However, because the annular shim disk 80 has the circular orifices 84 (rather than elongated slot orifices, for example) and does not have extraneous openings, the annular shim disk 80 bears, and more evenly distributes, the load of deflection. Additionally, the annular shim disk 80 may enhance sealing at the joint 72 because it is a single piece with no radial seam through which air can escape. Although the examples herein are described with respect to the joint 72 being located in the high pressure compressor 52, it is to be understood that similar joints that are subject to stacking tolerances may also benefit from this disclosure.

In comparison to the annular shim disk 80, a segmented shim includes eight arc segments. The arc segments are not bonded to each other but are individually secured in the joint (e.g., in place of the annular shim disk 80). Such a segmented shim may lead to higher stresses in comparison to the annular shim disk 80. The segments typically vary in thickness and thus add dimensional variation, may shift relative to one another in the joint, may clamp with different loads, and may include circumferentially elongated slots (to receive the fasteners and accommodate misalignment due to positioning of the arc segments). Deflection of one or both of the flanges 76b/78b may cause higher local stresses because of the non-uniform thickness, shifting, clamping loads, and elongated slots of the segmented shim. The higher local stress has the potential to reduce durability of one or more components in such a joint, such as low cycle fatigue durability and/or thermo-mechanical fatigue durability. The annular shim disk 80, however, facilitates a reduction in local stresses and potentially enhances durability of the first component 76, the second component 78, or both. For instance, in a computer analysis stress simulation of a range of maximum and minimum stresses, the annular shim disk 80 experienced a stress range 50% lower than the segmented shim and the annular shim disk 80 reduced the stress range in the second component 78 by over 30% in comparison to the segmented shim. Enhancement in durability may also provide greater flexibility to redesign other, surrounding components, which might otherwise reduce durability below acceptable levels.

Although a combination of features is shown in the illustrated examples, not all of them need to be combined to realize the benefits of various embodiments of this disclosure. In other words, a system designed according to an embodiment of this disclosure will not necessarily include all of the features shown in any one of the figures or all of the portions schematically shown in the figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A joint for a gas turbine engine, comprising:
a first component having a first ring portion and a first annular radial flange extending from the first ring portion;
a second component having a second ring portion and a second annular radial flange extending from the second ring portion,
the first annular radial flange and the second annular radial flange being spaced apart by a gap having a variable gap size that is subject to a stacking tolerance;
an annular shim disk disposed in the gap; and
a plurality of fasteners, each of the fasteners being secured through the first annular radial flange, the annular shim disk, and the second annular radial flange.

2. The joint as recited in claim 1, wherein the annular shim disk is monolithic.

3. The joint as recited in claim 1, wherein the annular shim disk includes a plurality of circular orifices through which the plurality of fasteners are secured.

4. The joint as recited in claim 3, wherein the circular orifices are circumferentially-arranged in a series that is uninterrupted by any non-circular orifices.

5. The joint as recited in claim 3, wherein the circular orifices are non-uniformly circumferentially-arranged.

6. The joint as recited in claim 1, wherein the second annular radial flange is scalloped.

7. The joint as recited in claim 1, wherein the first component includes an air seal extending from the first ring portion, the first annular radial flange extending radially outwards from the first ring portion and the air seal extending radially inwards from the first ring portion.

8. The joint as recited in claim 1, wherein the annular shim disk has radially inner and outer edges, and uniform axial thickness from the radially outer edge to the radially inner edge.

9. A gas turbine engine comprising:
a compressor section including,
a plurality of compressor case segments that are in a stacked arrangement along an axis, the compressor case segments having respective axial dimensions which are variable within respective dimensional tolerances, the stacked arrangement having a stacked dimension which is variable within a stacking tolerance corresponding to the dimensional tolerances; and
a joint including,
a first component having a first ring portion and a first annular radial flange extending from the first ring portion, the first component being stacked adjacent the second compressor case,
a second component having a second ring portion and a second annular radial flange extending from the second ring portion, the second component being affixed such that the first annular radial flange and the second annular radial flange are spaced apart by a gap having a variable gap size that is subject to the stacking tolerance,
an annular shim disk disposed in the gap, and
a plurality of fasteners, each of the fasteners being secured through the first annular radial flange, the annular shim disk, and the second annular radial flange.

10. The gas turbine engine as recited in claim 9, wherein the compressor section includes a low pressure compressor and a high pressure compressor, and the joint is located in the high pressure compressor.

11. The gas turbine engine as recited in claim 10, wherein the joint is at an aft end of the high pressure compressor.

12. The gas turbine engine as recited in claim 9, wherein the annular shim disk is monolithic.

13. The gas turbine engine as recited in claim 9, wherein the annular shim disk includes a plurality of circular orifices through which the plurality of fasteners are secured.

14. The gas turbine engine as recited in claim 13, wherein the circular orifices are circumferentially-arranged in a series that is uninterrupted by any non-circular orifices.

15. The gas turbine engine as recited in claim 13, wherein the circular orifices are non-uniformly circumferentially-arranged.

16. The gas turbine engine as recited in claim 9, wherein the second annular radial flange is scalloped.

17. The gas turbine engine as recited in claim 9, wherein the first component includes an air seal extending from the first ring portion, the first annular radial flange extending radially outwards from the first ring portion and the air seal extending radially inwards from the first ring portion.
